(19) United States
(12) Patent Application Publication
(10) Pub. No.: US 2013/0067459 A1
(43) Pub. Date: Mar. 14, 2013

(54) Order-Independent Deployment Collections with Dependency Package Identifiers

(71) Applicants: Hemchander Venkateshwara Sannidhanam, Bothell, WA (US); John M. Sheehan, Cambridge, MA (US); William L. Cheng, Redmond, WA (US); Zainab Hakim, Sammamish, WA (US); Jerome Thomas Holman, Redmond, WA (US)

(72) Inventors: Hemchander Venkateshwara Sannidhanam, Bothell, WA (US); John M. Sheehan, Cambridge, MA (US); William L. Cheng, Redmond, WA (US); Zainab Hakim, Sammamish, WA (US); Jerome Thomas Holman, Redmond, WA (US)

(73) Assignee: Microsoft Corporation, Redmond, WA (US)

(21) Appl. No.: 13/229,446

(22) Filed: Sep. 9, 2011

(51) Int. Cl. G06F 9/445

(52) U.S. Cl. 717/176; 717/174

(57) ABSTRACT

In accordance with one or more aspects, a first one or more packages are included in a deployment collection for a software product. One or more identifiers of each of a second one or more packages are also included in the deployment collection for the software product. The deployment collection is obtained at a device. For each of the second one or more packages, the package is obtained based on the identifier of the package, and the first one or more packages and the second one or more packages are installed on the device.

### BACKGROUND

Software products are oftentimes built using existing software libraries, allowing developers to leverage functionality included in the software libraries and thus build their software products easier and faster than they could without the software libraries. These software libraries can include software libraries authored by someone or some group other than the developer. When distributed, the software product can be a multi-package product that includes multiple different software packages such as software libraries, images, binaries, and so forth. However, generating such multi-package products including packages not authored by the developer has various problems. Generating such multi-package products as well as servicing those products as various packages not authored by the developer are updated can be time consuming and cumbersome for the developer. Additionally, having multiple multi-package products installed on a computer can result in having multiple copies of the same packages taking up valuable storage space on the computer, and can result in difficulties in determining when packages can be removed from the computer. Furthermore, these multi-package products can be very large in size, increasing the storage space used on the computer and bandwidth used transferring the multi-package products to the computer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a deployment collection for a software product is obtained at a device. The deployment collection includes a first one or more packages of the software product as well as one or more identifiers each identifying a second one or more packages of the software product, although the second one or more packages are absent from the deployment collection. For each of the second one or more packages, the package is obtained based on the identifier of the package, and the first one or more packages and the second one or more packages are installed on the device.

In accordance with one or more aspects, a first one or more packages are included in a deployment collection for a software product. One or more identifiers of each of a second one or more packages are also included in the deployment collection for the software product, and the deployment collection is provided to a deployment service.

### BRIEF DESCRIPTION OF THE DRAWINGS

The same numbers are used throughout the drawings to reference like features.

FIG. 1 illustrates an example system implementing the order-independent deployment collections with dependency package identifiers in accordance with one or more embodiments.

FIG. 2 illustrates an example multi-package software product in accordance with one or more embodiments.

FIG. 3 illustrates an example deployment collection for a software product in accordance with one or more embodiments.

FIG. 4 illustrates an example computing device on which a multi-package software product can be installed in accordance with one or more embodiments.

FIG. 5 is a flowchart illustrating an example process for providing a deployment collection for installing a software product in accordance with one or more embodiments.

FIG. 6 is a flowchart illustrating an example process for installing a software product in accordance with one or more embodiments.

FIG. 7 illustrates an example computing device that can be configured to implement the multi-package software products with dependency package identifiers in accordance with one or more embodiments.

### DETAILED DESCRIPTION

Order-independent deployment collections with dependency package identifiers is discussed herein. A software product is made up of multiple packages, each package including one or more components or modules (e.g., code, libraries, other resources, etc.). A deployment collection for the software product includes one or more manifests associated with the multiple packages. The manifest associated with a package indicates actions to be taken to install the package, as well as identifying other packages (if any) that the package is dependent on. The deployment collection also includes a main package for the software product, and can also optionally include additional ones of the multiple packages. However, the deployment collection need not include all of the multiple packages. Rather, the deployment collection can identify one or more of the multiple packages and rely on a deployment engine to obtain and install those one or more packages during installation of the software product.

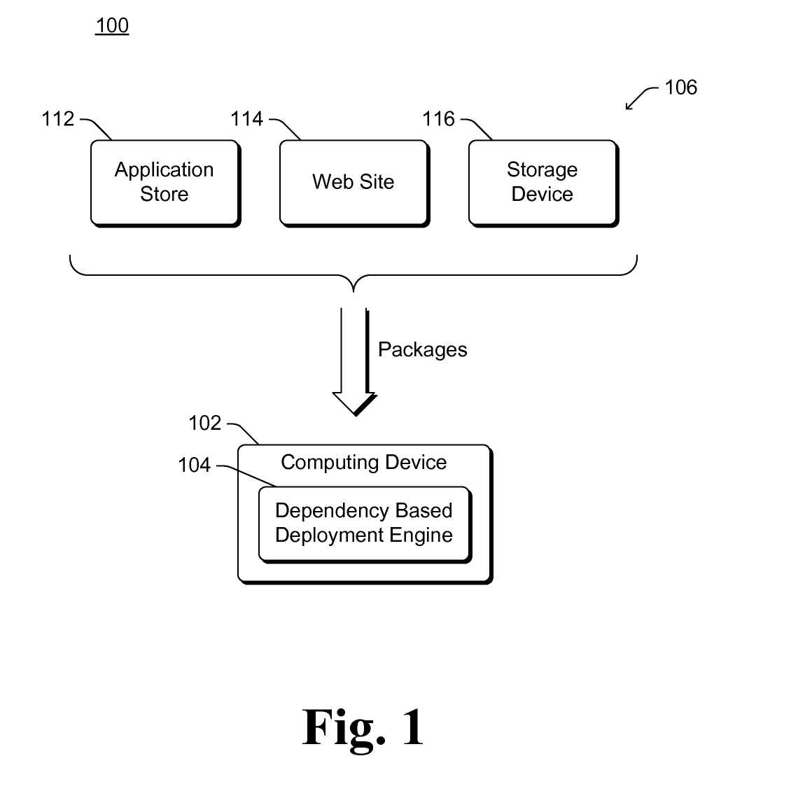

FIG. 1 illustrates an example system 100 implementing the order-independent deployment collections with dependency package identifiers in accordance with one or more embodiments. System 100 includes a computing device 102, which can be a variety of different types of devices, such as a physical device or a virtual device. For example, computing device 102 can be a physical device such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. Computing device 102 can also be a virtual device, such as a virtual machine running on a physical device. A virtual machine can be run on any of a variety of different types of physical devices (e.g., any of the various types listed above).

Computing device 102 includes a dependency based deployment engine 104 that obtains packages for software products and installs those packages on computing device 102. A software product refers to one or more applications that can be run on computing device 102. These software products typically include multiple packages, and thus are also referred to as multi-package software products. A package refers to one or more components or modules of the software product. Different types of packages can be included in a multi-package software product, such as a code or dependency type that includes binary code that is executed as part of the software product or code that is interpreted or otherwise processed as part of the software product, a resource type that includes text or images that are part of (resources of) the software product or other data that is part of the software product, a framework type that includes a framework (e.g., one or more libraries) that is part of the software product, and so forth.

Computing device 102 obtains packages for a software product from one or more of a variety of different package sources 106. Multiple packages can be obtained together (e.g., as part of a deployment collection for the software product), and/or individual packages can be obtained from multiple sources. Package sources 106 can include remote sources, such as an application store 112 or a Web site 114. Remote sources can be accessed via a variety of different networks, such as the Internet, a local area network (LAN), a public telephone network, an intranet, other public and/or proprietary networks, combinations thereof, and so forth. Package sources 106 can also include local sources, such as storage device 116. Storage device 116 can be a variety of different storage devices, such as a magnetic disk, an optical disc, a Flash memory device, and so forth. Local sources can be included as part of computing device 102, can be removable devices that are coupled to and de-coupled from computing device 102, can be devices in coupled to computing device 102 via a wired and/or wireless connection, and so forth.

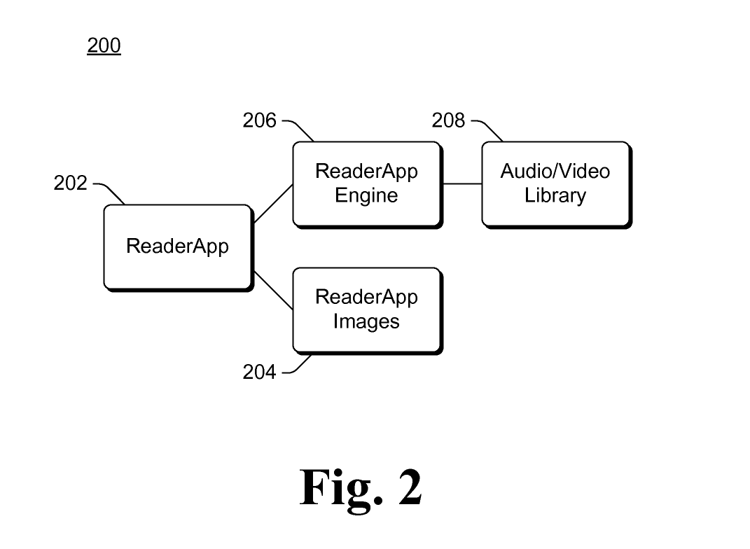

FIG. 2 illustrates an example multi-package software product 200 in accordance with one or more embodiments. Software product 200 includes multiple packages 202, 204, 206, and 208. Package 202 is a main package for software product 200, an application referred to as “ReaderApp”. The main package refers to the package that results in the application that is displayed (e.g., by name, icon, tile, etc.) when installed on a computing device. Package 204 is a set of one or more images for software product 200, and package 206 includes code that is executed as part of software product 200. Package 208 is an audio/video library that includes additional code that is executed as part of software product 200, and is typically provided by a developer other than the developer of software product 200. For example, package 208 can be a Microsoft DirectX® end-user runtime, available from Microsoft Corporation of Redmond, Wash.

Packages 204, 206, and 208 are dependency packages. A dependency package refers to a package that one or more other packages in software product 200 are dependent on. One package is dependent on another package if the one package relies on that other package to be present (installed) in order for an application in the one package to function correctly when running. Lines connecting ones of packages 202-208 illustrate which packages are dependent on which other packages, with the package towards the left of a particular line being dependent on a package toward the right of that particular line. For example, package 202 is dependent on package 206, and package 206 is dependent on package 208.

The packages included in software product 200, as well as the components or modules included in each package, are determined by the developer of software product 200. For example, rather than creating their own audio/video library 208, the developer of software product 200 can simply use an audio/video library 208 developed by another developer.

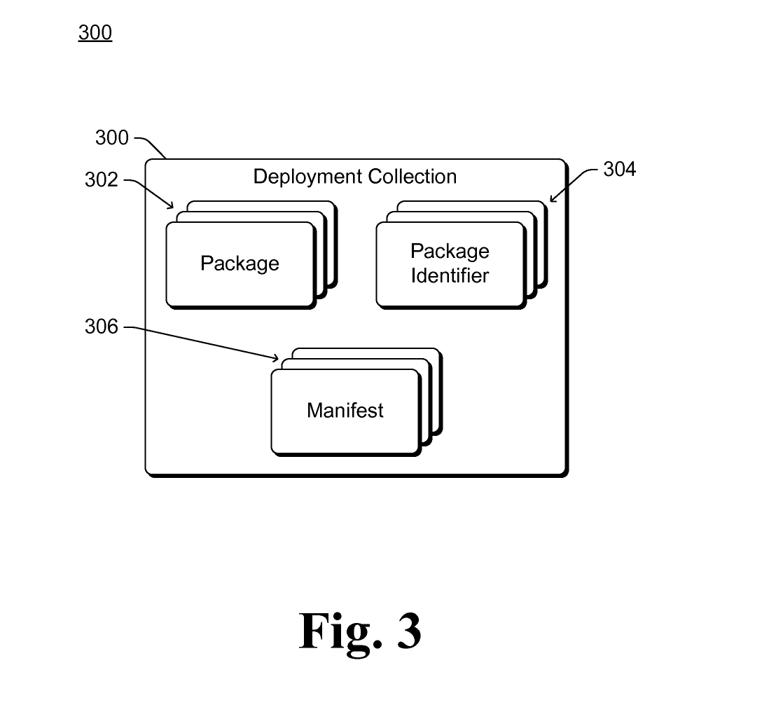

FIG. 3 illustrates an example deployment collection 300 for a software product in accordance with one or more embodiments. Deployment collection 300 includes one or more packages 302, as well as one or more identifiers 304 of packages. Deployment collection 300 need not include each package that is part of the software product. Rather, deployment collection 300 can include a reference to or an identifier of a package as one of identifiers 304, and rely on a deployment engine of a computing device on which the software product is being installed to obtain (if needed) and install the identified package. For example, deployment collection 300 can be a deployment collection for software product 200 of FIG. 2. Packages 202, 204, and 206 can be included as packages 302, and an identifier of package 208 can be included as an identifier 304. Thus, deployment collection 300 can include some packages for the software product, but other packages of the software product can be absent from (but referenced or identified in) deployment collection 300.

Deployment collection 300 also includes one or more manifests 306. Each package has an associated manifest that includes various metadata indicating actions to be taken to install the package. Although illustrated as separate from packages 302, the manifest associated with a package 302 can alternatively be included in the package 302. The manifest associated with a package identifies how to install the package, such as which files are to be written to disk, what configuration values are to be set (e.g., in an operating system registry or store), and so forth. The manifest associated with a package also includes dependency information for the package, identifying other packages (if any) that that package is dependent on. For example, the manifest associated with package 206 of FIG. 2 (which is included as a package 302) can identify that package 206 is dependent on package 208 of FIG. 2. Alternatively, the dependency information can be maintained elsewhere in deployment collection 300 rather than in manifests 306.

Each package in deployment collection 300, whether included as a package 302 or identified as a package identifier 304, has an associated package identifier. The package identifier for a package can be included in various locations, such as in the manifest associated with the package. The package identifier allows different packages to be distinguished from one another, and can identify the package in various manners. In one or more embodiments, the package identifier includes various elements, such as a name, a publisher, an architecture, a resource identifier, and/or a version. The name is a name assigned to package 302 by the developer of package 302. The developer can choose any name they desire. The publisher is a name of the publisher of package 302, which is typically the developer or distributor of package 302. The publisher can identify various entities such as a corporation, an individual, etc. The architecture refers to the processor and/or device architecture with which the components or modules of package 302 are designed to operate. The developer can choose one or more architecture identifiers to include as the architecture. Various different processor and/or device architectures can be identified, such as an x86 architecture, an x64 architecture, a RISC (reduced instruction set computer architecture), and so forth.

The version is a version of package 302. The developer can choose any versioning indications (e.g., numeric sequences, alphanumeric sequences, etc.) that they desire. The resource identifier can be any of a variety of different values or attributes identifying characteristics of package 302. The developer can choose any characteristics that they desire, such as the country or geographic region in which the components or modules of package 302 are designed to operate, the language (e.g., English, French, Japanese, etc.) that the components or modules of package 302 use, a form factor (e.g., desktop/laptop, tablet/slate, etc.) for which the components or modules of package 302 are designed to operate, one or more screen resolutions for which the components or modules of package 302 are designed to operate, whether the package 302 includes trial versions or fully licensed versions of applications, and so forth.

Each package can have its own associated manifest, or alternatively a single manifest can be associated with multiple packages. For a package identified by an identifier 304, deployment collection 300 can include the manifest associated with the identified package. Alternatively, the manifest associated with the identified package can be obtained by the deployment engine during installation of the software product (e.g., from the same source from which the identified package is obtained).

Deployment collection 300 can also optionally include an action list that identifies each package included in the software product. The action list identifies packages included as packages 302, as well as packages identified by identifiers 304. Alternatively, such an action list can be generated by a deployment engine during installation of the software product, as discussed in more detail below.

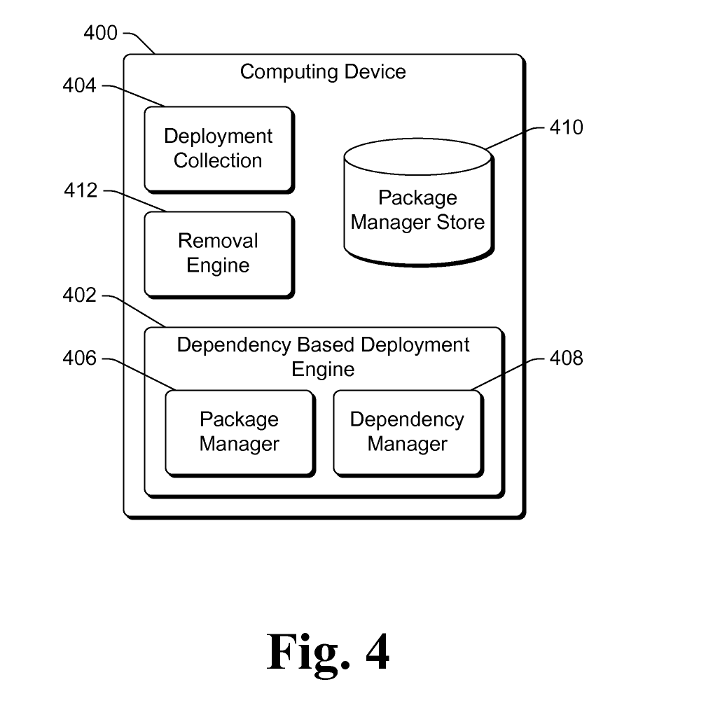

FIG. 4 illustrates an example computing device 400 on which a multi-package software product can be installed in accordance with one or more embodiments. Computing device 400 can be, for example, a computing device 102 of FIG. 1. Computing device 400 includes a dependency based deployment engine 402, which can be a dependency based deployment engine 104 of FIG. 1. Deployment engine 402 installs a software product based on a deployment collection 404.

Generally, to install a software product based on deployment collection 404, deployment engine 402 identifies the packages included in the software product and verifies that each is available. Deployment engine 402 then checks which packages are to be installed on computing device 400 for the software product. Some packages may already be installed on computing device 400 and thus do not need to be installed and/or multiple different versions of the same package may be available from which one version is selected to be installed on computing device 400. Deployment engine 402 then proceeds to install those packages that are to be installed on computing device 400 for the software product.

More specifically, deployment engine 402 includes a package manager 406 and a dependency manager 408. Package manager 408 manages the installation of the software product based on deployment collection 404 and dependency manager 408 generates a resolved set of packages. The resolved set of packages is an identification of the packages that are to be installed on computing device 400 for the software product.

Deployment engine 402 also maintains a package manager store 410, in which deployment engine 402 stores various information regarding packages installed on computing device 400, including an identification of each package (e.g., the package identifier of the package) installed on computing device 400 and the manifests associated with packages installed on computing device 400. Deployment engine 402 also stores in package manager store 410, for each package that is installed on computing device 400, an identification of any other packages that the package is dependent on. Thus, package manager store 410 includes not only an indication of each package that is installed on computing device 400, but also includes an indication of the dependencies of those packages on one another. The dependency information can be maintained using a table, dependency graph, or alternatively a variety of other conventional data structures.

Package manager 406 obtains an indication of a deployment collection 404. This indication can be obtained in a variety of different manners. For example, the indication can be received from an application store (e.g., in response to a user selection of a software product in the application store that he or she would like installed on computing device 400), from a storage device, from another computing device, and so forth. The indication can be deployment collection 404 itself, or a pointer to or other identifier of where deployment collection 404 can be obtained by deployment engine 402.

Package manager 406 evaluates deployment collection 404 and verifies that the packages of the software product being installed are available. Each package of the software product being installed has a package identifier, and a particular package of the software product being installed is available if a package having the same package identifier as that particular package is available. The packages of the software product being installed refer to both packages included in deployment collection 404 and packages identified in deployment collection 404. A list of the packages (e.g., package identifiers) of the software product being installed is obtained or generated, and this list is referred to as the action list. The packages of the software product being installed can be identified in different manners. For example, if deployment collection 404 includes an action list, then the packages of the software product being installed are identified on the action list. By way of another example, the dependency information in deployment collection 404 can be analyzed, identifying for each package zero or more other packages that the package is dependent on. By parsing the dependency information, a list of the packages of the software product being installed is generated and used as the action list.

Package manager 406 also verifies that the packages of the software product being installed are available to deployment engine 402. Packages are available to deployment engine 402 if the packages are already installed on computing device 400 or can be obtained for installation by deployment engine 402. For example, a package that is included in deployment collection 404 is available to deployment engine 402. By way of another example, if a package is already installed on computing device 400 (e.g., package manager store 410 indicates that a package having the identifier of that package is already installed on computing device 400), then that package is available to deployment engine 402. By way of another example, if a package can be obtained from another source (e.g., an application store, another computing device, a web site, etc.), then that package is available to deployment engine 402. An identification of one or more other sources from which a package can be obtained can be determined in different manners, such as being pre-configured in package manager 406, being included in deployment collection 404, and so forth.

If package manager 406 determines that one or more of the packages of the software product being installed are not available to deployment engine 402, then deployment engine 402 does not install the software product on computing device 400. However, if package manager 406 determines that the packages of the software product being installed are available to deployment engine 402, then package manager 406 notifies dependency manger 408 to determine which packages are to be installed for the software product. In one or more embodiments, dependency manager 408 generates a resolved set of packages, which identifies the packages that are to be installed for the software product.

Dependency manager 408 can determine which packages are to be installed for the software product in a variety of different manners. In one or more embodiments, dependency manager 408 starts with a resolved set of packages that includes the packages on the action list, and then removes or modifies packages from the resolved set of packages based on one or more rules to generate the resolved set of packages. Packages in the resolved set of packages are typically removed or modified due to the packages already being installed on computing device 400, or due to multiple versions of packages being available to deployment engine 402. Various different rules or criteria can be used to determine whether to remove or modify a package in the resolved set of packages, thus selecting which packages will be installed on computing device 400. Different rules can optionally be used for different types of dependency packages. For example, one set of rules can be used for framework packages, another set of rules can be used for resource packages, and so forth.

A variety of different rules can be used by dependency manager 408, and these rules can optionally be based on various elements of the identifier of the package (e.g., name, publisher, version, etc.). For example, one rule can be that if the package is already installed on computing device, then the package is removed from the resolved set of packages. By way of another example, a rule can be that if multiple versions of a package are available, then the most recent version of the package (e.g., the package having the highest version number) is included in the resolved set of packages (possibly replacing a previous version of the package in the resolved set of packages). By way of yet another example, a rule can be that if multiple versions of a package are available, then the most recent version of the package (e.g., the package having the highest version number) that is not too recent (e.g., has a version number not greater than a threshold number) is included in the resolved set of packages (possibly replacing a previous version of the package in the resolved set of packages).

In one or more embodiments, the following rules are applied in situations in which multiple versions of a package are available to deployment engine 402. Two packages are versions of the same package if the two version have the same name, publisher, architecture, and resource identifier. If a package has the same name as another package but does not have the same publisher, architecture, and resource identifier, then an error occurs and deployment engine 402 does not install the software product. Alternatively, the following rules can be applied if one or more of the name, publisher, architecture, and/or resource identifier are not the same (e.g., the following rules can be applied if the architectures of the two versions are not the same, but are both included in a particular set of architectures). These rules can be applied for particular types of packages (e.g., framework packages), or alternatively can be applied for all types of packages. The rules are: (1) if the package identified on the action list is a less recent version of the package (e.g., the package has a lower version number) than is already installed on computing device 400, then an error occurs and deployment engine 402 does not install the software product; (2) if the package identified on the action list is a more recent version of the package (e.g., the package has a higher version number) than is already installed on computing device 400, then the more recent version of the package remains in the resolved set of packages.

Dependency manager 408 provides the resolved set of packages to package manager 406. If a package is not in deployment collection 404 or already installed on computing device 400, but can be obtained from another source, then package manager 402 obtains the package from that source (e.g., by sending a request for the package to that source, the request including a package identifier of the package). Package manager 406 installs the software product on computing device 400 by installing the resolved set of packages on computing device 400. The particular actions to take in order to install each package of the resolved set of packages on computing device 400 is identified in the manifest associated with the package as discussed above. The resolved set of packages are installed as part of a single transaction—additional packages not included in the resolved set of packages are not installed (although can subsequently be installed if included in or identified in another deployment collection). As part of the installation of the software product on computing device 400, package manager 406 stores indications of the packages and dependency information in package manager store 410 as discussed above.

It should be noted that package manager 406 can automatically determine the order in which packages are installed as part of installing the software product on computing device 400. The order of installation of packages need not be expressly recited in deployment collection 404, and deployment collection 404 can thus be referred to as being order-independent. Package manager 406 can automatically determine the order of installation of packages based on the dependency information for the packages of the software product. In one or more embodiments, package manager 406 follows a rule that if one package is dependent on another package, then package manager 406 installs the other package before installing the one package. Thus, the installation order determined by package manager 406 is that packages on which other packages depend are installed before those other packages. A package that is not dependent on another package can be installed in any order (either package can be installed before the other).

Computing device 400 also includes a removal engine 412, which manages removal (uninstalling) of packages from computing device 400. Removal engine 412 can determine when to remove a package in a variety of different manners, such as in response to a request from a user of computing device 400 to remove a software product (e.g., an identifier of a main package of the software product added to package manager store 410 can be obtained by removal engine 412), in response to a request from another component or module of computing device 400, and so forth. The manner in which a package is removed from computing device 400 can be determined in a variety of different manners, such as based on the manifest associated with the package (which can include information identifying how to uninstall the package, including which files to delete, which configuration settings or values to change, etc.).

In one or more embodiments, dependency based deployment engine 402 also facilitates removal of packages from computing device 400. When removing a package, removal engine 412 notifies package manager 406 of the package being removed (e.g., provides an identifier of the package to package manager 406). Based on the dependency information in package manager store 410, package manager 406 generates a removal list that identifies the packages to be removed. The removal list initially includes the package identified by removal engine 412. Furthermore, any additional packages that the identified package is dependent on (or any other packages that such an additional package is dependent on) and for which no other package is dependent on are added to the removal list. For example, referring to FIG. 2, if the identified package were package 202, then for each of packages 204, 206, and 208, the package would be added to the removal list if no other packages installed on the computing device were dependent on the package. However, for any of packages 204, 206, and 208, if at least one other package installed on the computing device were dependent on the package, then the package would not be added to the removal list.

It should be noted that situations can arise in which another package is dependent on the package identified by removal engine 412. In such situations, the package identified by removal engine 412 is removed from the removal list. Thus, situations can arise in which there are no packages on the removal list.

Package manager 406 returns the removal list to removal engine 412, which proceeds with removing the packages on the removal list from computing device 400. Additionally, for each package on the removal list, dependency manager 408 removes the indication of the package from package manager store 410, and further removes any indication of dependency information for the package from package manager store 410.

Additionally, in one or more embodiments package manager 406 maintains, for each package in package manager store 410, an indication of whether the package was explicitly installed or implicitly installed. A package is explicitly installed if a user requested that the package be installed (e.g., the user selected an application corresponding to a main package). A package is implicitly installed if a user did not request that the package be installed (e.g., the package is a dependency package in a deployment collection). Package manager 406 does not add packages that are explicitly installed to the removal list, although package manager 406 does allow an explicitly installed package to remain on the removal list if the explicitly installed package is the package identified by removal engine 412.

It should also be noted that package manager store 410 can combine dependency information for multiple users of computing device 400. Different users can request different software products be installed, each having various dependency packages. Thus, situations can arise in which two different packages of two different software products that two different users requested be installed are dependent on the same dependency package. If one user were to request that one of the software products be uninstalled, the dependency package would not be removed because another package (installed in response to a request by another user to install another software product) is still dependent on the dependency package.

Additionally, when a software product is installed, an indication of which user requested that the software product be installed can be included in package manager store 410 for each package installed for the software product. Based on such indications, package manager 406 can include on the removal list indications of packages that are not to be removed from computing device 400, but for which any configuration settings or values are to be changed as if the packages were removed. These packages can be, for example, packages that would have been removed but are not removed because a package installed as part of another software product for another user is still dependent on the packages. During removal of the identified packaged for a particular user, removal engine 412 modifies any configuration settings or values as if the package were being removed for that user, although the files that would be deleted are not actually deleted.

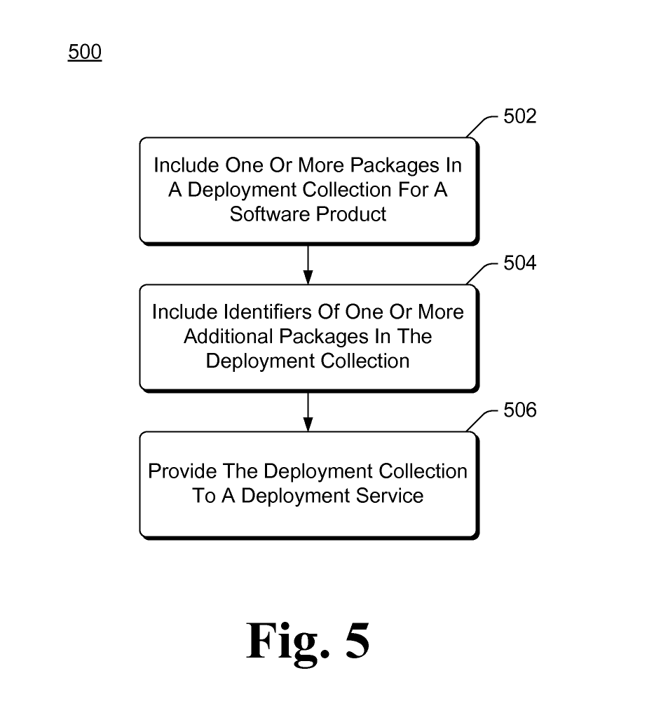

FIG. 5 is a flowchart illustrating an example process 500 for providing a deployment collection for installing a software product in accordance with one or more embodiments. Process 500 is carried out by a device, such as computing device 102 of FIG. 1 or computing device 400 of FIG. 4, and can be implemented in software, firmware, hardware, or combinations thereof. Process 500 is shown as a set of acts and is not limited to the order shown for performing the operations of the various acts. Process 500 is an example process for providing a deployment collection for installing a software product; additional discussions of providing a deployment collection for installing a software product are included herein with reference to different figures.

In process 500, one or more packages are included in a deployment collection for a software product (act 502). These packages can be a variety of different types of packages as discussed above. The packages included in the deployment collection are identified by, for example, a developer of the software product.

Identifiers of each of one or more additional packages are also included in the deployment collection (act 504). Although identifiers of the one or more additional packages are included in the deployment collection, the one or more additional packages themselves are not included in the deployment collection. These one or more additional packages can be a variety of different types of packages as discussed above.

The deployment collection is provided to a deployment service (act 506). The deployment service can be a variety of different sources for packages as discussed above, such as an application store, web site, and so forth.

It should be noted that various additional information can also optionally be included in the deployment collection. For example, an action list as discussed above can be included in the deployment collection. By way of another example, one or more manifests associated with the one or more packages of act 502 and/or the one or more additional packages of act 504 can be included in the deployment collection.

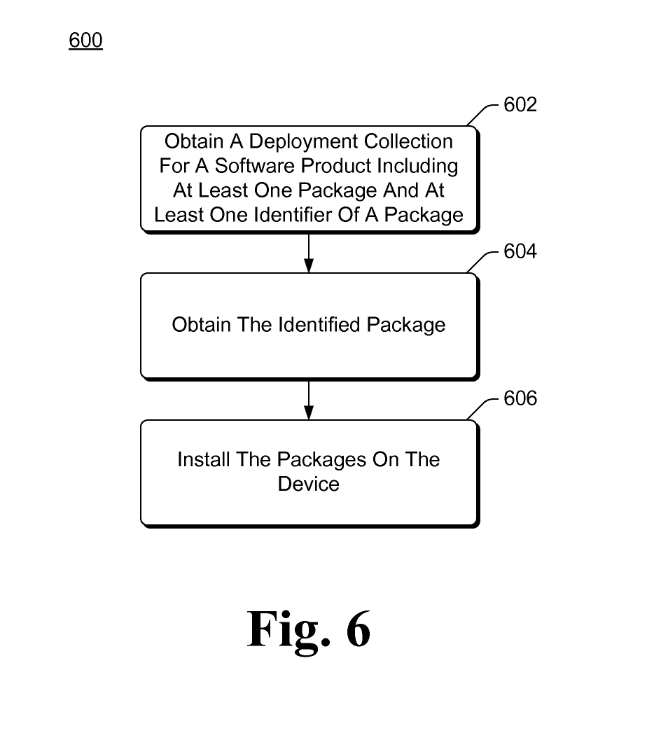

FIG. 6 is a flowchart illustrating an example process 600 for installing a software product in accordance with one or more embodiments. Process 600 is carried out by a device, such as computing device 102 of FIG. 1 or computing device 400 of FIG. 4, and can be implemented in software, firmware, hardware, or combinations thereof. Process 600 is shown as a set of acts and is not limited to the order shown for performing the operations of the various acts. Process 600 is an example process for installing a software product; additional discussions of installing a software product are included herein with reference to different figures.

In process 600, a deployment collection for a software product is obtained (act 602). The deployment collection includes at least one package and also an identifier of at least one other package (although the at least one other package is absent from the deployment collection). These packages can be a variety of different types of packages as discussed above.

For each identifier of a package, the identified package is obtained (act 604). The identified package can be obtained from a variety of different sources as discussed above.

The packages are installed on the device (act 606). The packages installed on the device include both the at least one package included in the deployment package and the at least one package obtained in act 604.

The order-independent deployment collections with dependency package identifiers techniques discussed herein support various usage scenarios. For example, a developer of a software product that relies on libraries or other packages developed by others can readily include those libraries or other packages by reference in the deployment collection for the software product. The developer need not obtain and include those libraries or other packages in the deployment collection for the software product, but rather can simply include identifiers of those libraries or other packages in the deployment collection. By way of another example, dependency information indicating which packages installed on a computing device are dependent on which other packages installed on the computing device is maintained. This dependency information can then be used in various manners, such as identifying one or more additional packages that can be removed when a particular other package is being removed.

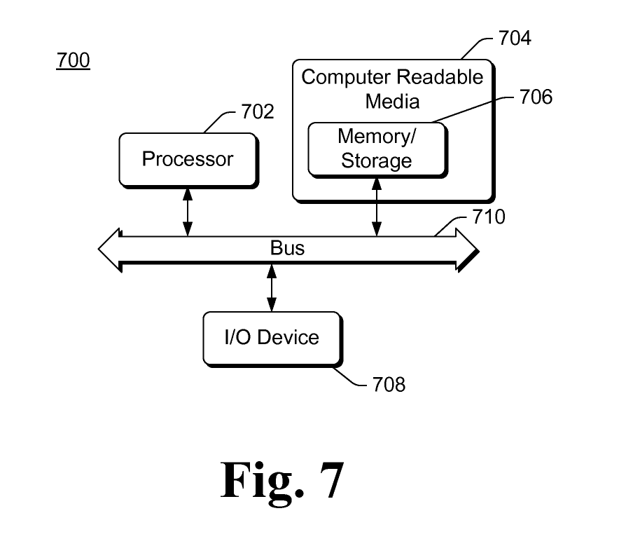

FIG. 7 illustrates an example computing device 700 that can be configured to implement the order-independent deployment collections with dependency package identifiers in accordance with one or more embodiments. Computing device 700, for example, can be computing device 102 of FIG. 1 or computing device 400 of FIG. 1, or can implement at least part of application store 112, web site 114, and/or storage device 116 of FIG. 1.

Computing device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or one or more I/O devices 708 can be included as part of, or alternatively may be coupled to, computing device 700. Processor 702, computer readable media 704, one or more of devices 708, and/or bus 710 can optionally be implemented as a single component or chip (e.g., a system on a chip). Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 702. It is to be appreciated that different instructions can be stored in different components of computing device 700, such as in a processing unit 702, in various cache memories of a processing unit 702, in other cache memories of device 700 (not shown), on other computer readable media, and so forth. Additionally, it is to be appreciated that the location where instructions are stored in computing device 700 can change over time.

One or more input/output devices 708 allow a user to enter commands and information to computing device 700, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communication media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Computer storage media refer to media for storage of information in contrast to mere signal transmission, carrier waves, or signals per se. Thus, computer storage media refers to non-signal bearing media, and is not communication media.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 7. In the case of hardware implementation, the module or component represents a functional block or other hardware that performs specified tasks. For example, in a hardware implementation the module or component can be an application-specific integrated circuit (ASIC), field-programmable gate array (FPGA), complex programmable logic device (CPLD), and so forth. The features of the order-independent deployment collections with dependency package identifiers techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining, at a device, a deployment collection for a software product, the deployment collection including a first one or more packages and one or more identifiers of each of a second one or more packages, the second one or more packages being absent from the deployment collection;
obtaining, for each of the second one or more packages, the package based on the identifier of the package; and
installing the first one or more packages and the second one or more packages on the device.

2. A method as recited in claim 1, further comprising, for each of the first one or more packages and each of the second one or more packages, installing the package only if the package is not already installed on the device.

3. A method as recited in claim 1, further comprising verifying whether each of the first one or more packages and each of the second one or more packages is available, and installing the first one or more packages and the second one or more packages only if each of the first one or more packages and each of the second one or more packages is available.

4. A method as recited in claim 1, further comprising obtaining the deployment collection from an application store via a network.

5. A method as recited in claim 1, further comprising automatically determining an order of installation for the first one or more packages and the second one or more packages based at least in part on dependency information associated with the first one or more packages and the second one or more packages.

6. A method as recited in claim 1, further comprising:
generating a resolved set of packages based on a list of packages included in the software product;
removing, from the resolved set of packages, each package included in the software product that is already installed on the device; and
the installing comprising installing the packages in the resolved set of packages.

7. A method as recited in claim 1, the obtaining the package based on the identifier of the package comprising obtaining the package from a remote source accessed via a network.

8. A method as recited in claim 1, the obtaining the package based on the identifier of the package comprising obtaining the package from a local storage device.

9. A method as recited in claim 1, further comprising, for each of the first one or more packages and each of the second one or more packages, if multiple versions of the package are available then selecting one of the multiple versions to install based at least in part on identifiers of the multiple versions of the package.

10. A method as recited in claim 9, further comprising, for each of the first one or more packages and each of the second one or more packages, if multiple versions of the package are available then installing a most recent version of the package.

11. A method as recited in claim 9, two versions of a package being versions of the same package only if the two versions have the same name, the same publisher, and the same resource identifier.

12. A method as recited in claim 1, further comprising:
maintaining an indication of each package installed on the device in a package manager store; and
maintaining an indication of the dependencies of the packages installed on the device in the package manager store.

13. A method as recited in claim 1, further comprising
receiving a request to remove a software product from the device;
identifying a package of the software product;
generating, based on dependency information indicating multiple packages installed on the device and dependencies of ones of those multiple packages on others of the multiple packages, a removal list identifying zero or more packages to be removed; and
removing the zero or more packages identified in the removal list from the device.

14. A method as recited in claim 13, further comprising adding one or more additional packages to the removal list, the one or more additional packages including one or more of the multiple packages that are dependent on the package.

15. A method as recited in claim 13, further comprising removing the package from the removal list if another of the multiple packages is dependent on the package.

16. One or more computer storage media having stored thereon multiple instructions that, when executed by one or more processors of a computing device, cause the one or more processors to:
include, in a deployment collection for a software product, a first one or more packages;
include, in the deployment collection for the software product, one or more identifiers of each of a second one or more packages; and
provide the deployment collection to a deployment service.

17. One or more computer storage media as recited in claim 16, each of the second one or more packages being absent from the deployment collection.

18. One or more computer storage media as recited in claim 16, the multiple instructions further causing the one or more processors to include, for each of the first one or more packages and the second one or more packages, both an identifier of the package and an identification of any other packages that the package is dependent on in a manifest associated with the package.

19. One or more computer storage media as recited in claim 16, the deployment service comprising an application store.

20. A method comprising:
obtaining, at a device, from an application store a deployment collection for a software product, the deployment collection including a first one or more packages and one or more identifiers of each of a second one or more packages, the second one or more packages being absent from the deployment collection;
obtaining, for each of the second one or more packages, the package based on the identifier of the package; and
installing in an order determined based on dependency information associated with the first one or more packages and the second one or more packages, for each of the first one or more packages and the second one or more packages on the device, the package if the package is not already installed on the device.
